(19) United States
(12) Patent Application Publication
(10) Pub. No.: US 2003/0023777 A1
(43) Pub. Date: Jan. 30, 2003

(54) Dynamic address assignment for one-wire interface

(76) Inventors: Ken Fields, San Jose, CA (US); Wolfgang Himmelbauer, San Jose, CA (US); Aashit Patel, San Jose, CA (US); Dave Ritter, (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/916,786

(22) Filed: Jul. 27, 2001

(51) Int. Cl. G06F 3/00

(52) U.S. Cl. 710/3

(57) ABSTRACT

A method for identifying and assigning an address of a particular device is disclosed. The method includes discharging a capacitor in response to a first command from a host. A voltage of the discharged capacitor is then measured in response to a second command from the host. The address is assigned to the particular device when the voltage indicates that the particular device is an intended destination of the address.

### BACKGROUND

1. Field of the Invention

The present invention relates to a single-wire interface, and more particularly, to dynamic address assignment on such an interface.

2. Prior Art

Shared resources on devices connected to a host system are often accessed through a shared interface, such as a bus. Thus, a device that is connected to such a bus may be identified by a device number or address. Device address assignment for one-pin interface is currently done by assigning a unique number to each device during the manufacturing process using expensive laser equipment. Moreover, a sophisticated accounting system may need to be put in place during the manufacturing flow to ensure uniqueness of the assigned addresses. Accordingly, this device address assignment technique may significantly increase the manufacturing cost of the product.

One solution to the difficulty with the above-described device address assignment technique may be to increase the pin count on the device. However, problem with this solution is that if the number of pins required exceeds the number that can be supported in a single integrated chip, then multiple chips must be used for the device circuitry. Furthermore, number of wires on the bus must also be increased. This may be disadvantageous because circuitry and bus generally become more complex and consume more power under this design. Therefore, one-pin interface may be valuable in the implementation of device interfaces on integrated circuits with small pin count packages.

### SUMMARY

The present invention, in one aspect, describes a method for identifying and assigning an address of a particular device. The method includes discharging a capacitor in response to a first command from a host. Voltage of the discharged capacitor is then measured in response to a second command from the host. The address is assigned to the particular device when the voltage indicates that the particular device is an intended destination of the address.

In an alternative embodiment, the method for identifying and assigning a device address includes providing a combination of resistor and capacitor of selected sizes. The combination produces a particular time constant. This particular time constant is then compared to a threshold time. The device address is identified and assigned according to an outcome of the comparison.

In another aspect, the present invention describes an address identification and assignment system. The system includes a combination of resistor and capacitor, a voltage reference, a switching element, and a comparator. The voltage reference provides a capacitor charge voltage and a threshold voltage. The switching element enables charging and discharging of the capacitor, where the capacitor is charged to the capacitor charge voltage. The comparator compares voltage of the discharged capacitor with the threshold voltage.

### BRIEF DESCRIPTION OF THE DRAWINGS

FIG. 1 is a block diagram of a single-wire interface system with dynamic address assignment according to an embodiment of the present invention.

FIG. 2 illustrates a schematic diagram of an address identification and assignment module in accordance with an embodiment of the present invention.

FIG. 3 shows a timing diagram of an address identification and assignment system.

FIG. 4 illustrates a single-pin bi-directional interface system showing N number of devices and a host connected to the interface.

FIG. 5 illustrates a device address identification and assignment process in accordance with an embodiment of the present invention.

FIG. 6 is a block diagram of a device interface module according to an embodiment of the present invention.

### DETAILED DESCRIPTION

In recognition of the above-stated difficulties with prior techniques of device address assignment, the present invention describes embodiments for a single-pin interface having dynamic address assignment. The present embodiments include dynamically identifying and assigning an address using a uniquely specified time constant for each device connected to the interface. Consequently, for purposes of illustration and not for purposes of limitation, the exemplary embodiments of the invention are described in a manner consistent with such use, though clearly the invention is not so limited.

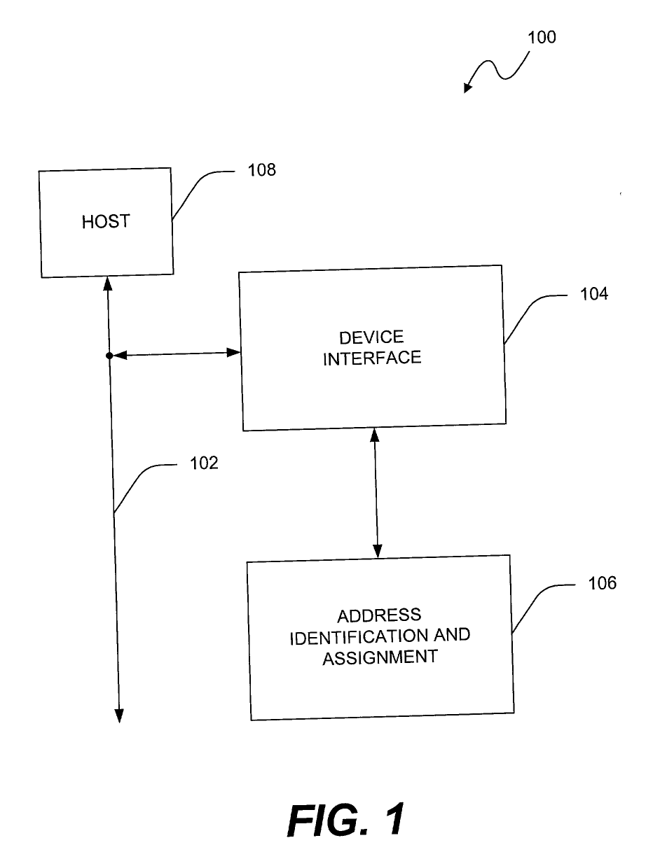

A block diagram of a single-wire interface system 100 with dynamic address assignment according to an embodiment of the present invention is shown in FIG. 1. The interface system 100 includes a single-pin bus 102 which carries data in both directions on a single wire. The bi-directional interface system 100 also includes a host 108, a device interface module 104, and an address identification and assignment module 106.

In the illustrated embodiment, the host 108 sends and receives data to and from devices by interfacing with the single-pin bus 102. On the device side, the device interface module 104 receives data pulses on the bus 102 and decodes the pulses to determine bits in the data. Moreover, in this embodiment, the device interface module 104 also writes to the bus 102 by presenting logic levels of data bits in the registers of the interface module 104 to the bus 102. Further, the address identification and assignment module 106 dynamically identifies and assigns an address for the present device by comparing the pulse width of an initiation pulse from the host 108 with a pre-programmed time constant. The assignment enables the device interface module 104 to determine whether the data or address on the bus 102 received from the host 108 is intended for the present device.

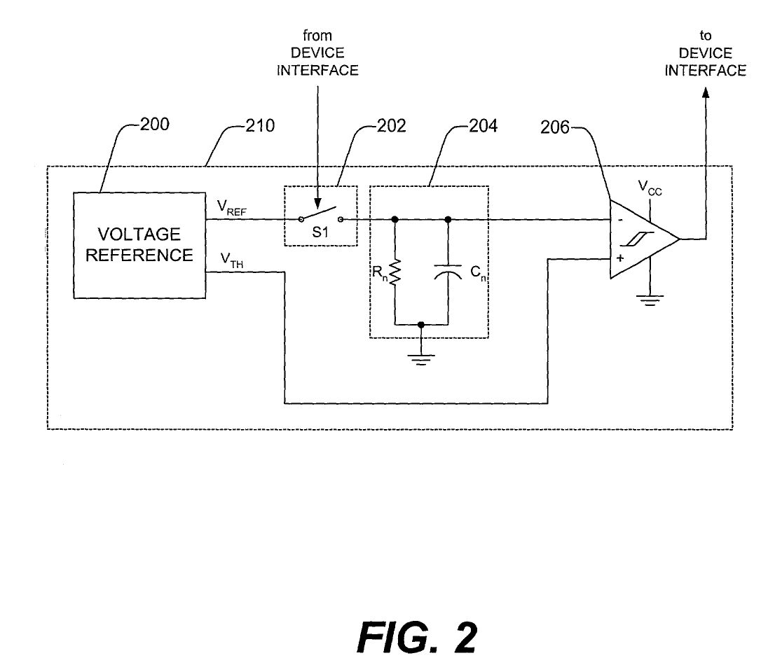

A schematic diagram of the address identification and assignment module 210 is shown in FIG. 2 in accordance with an embodiment of the present invention. This module 210 is substantially equivalent to the module 106 in FIG. 1. The identification and assignment module 210 includes a voltage reference 200, a switch 202, an RC circuit 204, and a comparator 206.

In an identification mode, the identification and assignment module 210 uniquely identifies each device on the bus 102. Specifically, device n on the bus 102 is identified by a unique time constant provided by an RC circuit 204 of resistor (Rₙ) and capacitor (Cₙ), where n=1, 2, . . . , N.

To produce this unique time constant, the switch 202 in each device is initially commanded to close. The closing of the switch 202 charges the capacitor Cₙ in the RC circuit 204 to a reference voltage (V_{REF}) provided by the voltage reference 200. To start the identification process, the host 108 may then send a valid initialization command and an initiation pulse to the device interface module 104.

In one embodiment, the leading edge of the initiation pulse directs the device interface module 104 to command the switch 202 to open. This enables the capacitor Cₙ in the RC circuit 204 to discharge. At the trailing edge of the initiation pulse, the voltage on the discharged capacitor Cₙ is compared to a threshold voltage (V_{TH}) provided by the voltage reference 200. This comparison may be made in the comparator 206.

If the voltage on the discharged capacitor Cₙ, at the trailing edge of the initiation pulse, is larger than the threshold voltage (V_{TH}), then the present device is identified by the address identification and assignment module 210. Thus, this indicates that the host 108 has identified the present device as the intended destination for the address on the bus 102. The device interface module 104 then accepts the address on the bus 102, and writes that address to the address register. Furthermore, the device interface module 104 may lock itself into a state that does not accept future initiation pulses so that other devices with smaller time constants may be identified and assigned.

Although the method of providing a unique time constant is described above in terms of varying the capacitor in the device interface module, other parameters may be varied to provide the unique time constant. For example, in an alternative embodiment, the unique time constant may be provided by varying resistor Rₙ, where n=1, 2, . . . , N. In a further embodiment, both resistor (Rₙ) and capacitor (Cₙ) may be adjusted to provide the unique time constant.

Other parameters may also be employed to identify and assign devices connected to a single-pin interface. For example, the threshold voltage (V_{TH}) may be varied for each device while the resistor and the capacitor are fixed. Thus, the device may be identified and assigned by comparing the variable threshold voltage (V_{TH}) with a fixed time constant. However, in some implementations, the time constant may also be varied.

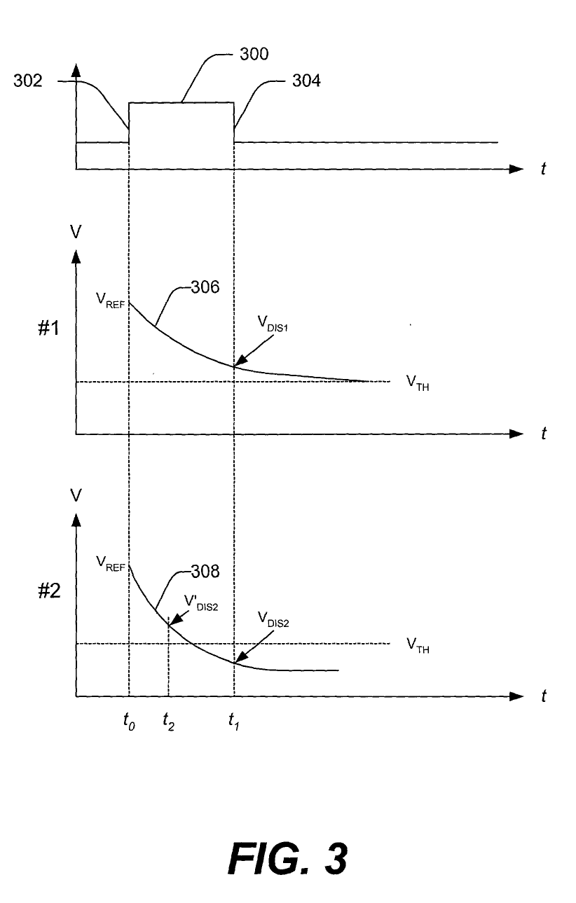

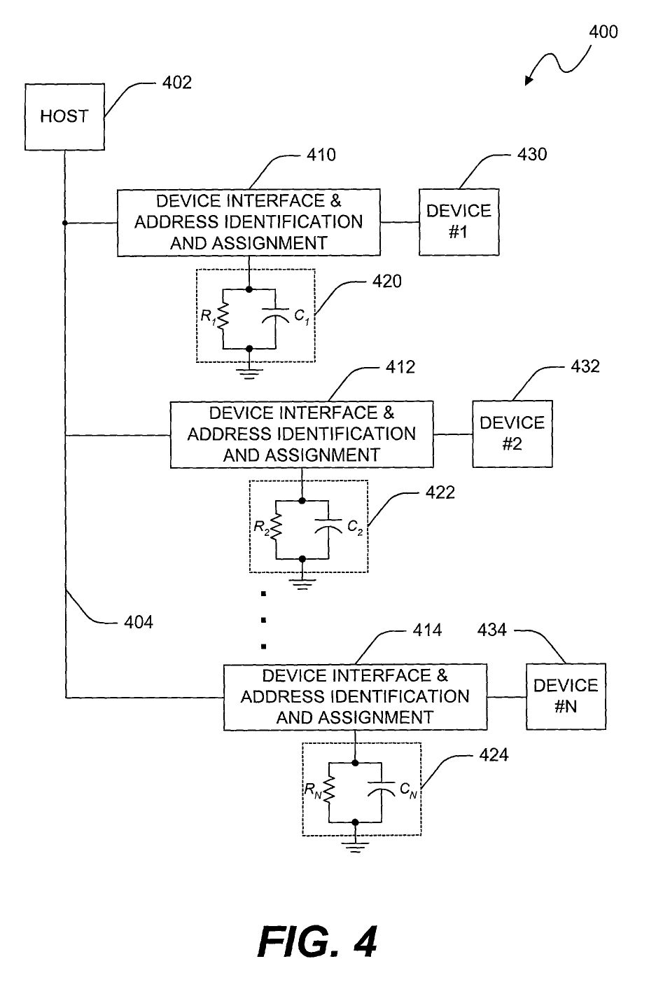

The identification process is further explained below in detail in conjunction with a timing diagram of FIG. 3 and a device interface system of FIG. 4. The timing diagram illustrates the identification process according to an embodiment of the present invention. The illustrated embodiment shows a process of identifying two devices, device #1 and device #2, connected to the bus 102. This process may be repeated to identify and initialize all N devices on the bus 102.

Closing of switches 202 in devices #1 and #2 charges capacitors C₁ and C₂ (see FIG. 4), respectively, to the reference voltage (V_{REF}) Furthermore, the host 108 may then send a valid initialization command and an initiation pulse 300 to the device to start the identification process.

In the illustrated embodiment, the leading edge (t₀) 302 of the initiation pulse 300 opens the switches 202, and enables the capacitors C₁ and C₂, to discharge from the initial reference voltage (V_{REF}). The discharge profiles of devices #1 and #2 are shown at 306 and 308, respectively. At the trailing edge (t₁) 304 of the initiation pulse 300, the voltages, V_{DIS1} and V_{DIS2}, of devices #1 and #2, respectively, are compared to the threshold voltage (V_{TH}) provided by the voltage reference 200. The discharge profiles 306, 308 indicate that the voltage on device #1 (V_{DIS1}) is greater than the threshold voltage (V_{TH}), while the voltage on device #2 (V_{DIS2}) is less than the threshold voltage (V_{TH}). Thus, this indicates that the host 108 has identified device #1 as the intended destination for the address on the bus 102. Accordingly, the device interface module 104 of device #1 may accept and write the address on the bus 102 to the address register. Furthermore, the device interface module 104 of device #1 may lock itself into a state that does not accept future initiation pulses so that other devices, such as device #2, with smaller time constants may be identified and assigned. Therefore, once the first device with the longest time constant is initialized and locked out, the device with next longest time constant may be initialized.

For example, to identify and assign device #2, the host 108 may subsequently send another initiation pulse with a smaller pulse width. Specifically, the host 108 may send an initiation pulse that has its leading edge at t₀ and trailing edge at t₂. The initiation pulse provides a voltage (V′_{DIS2}) which is greater than the threshold voltage (V_{TH}) Thus, device #2 is identified as the intended destination for the address on the bus 102. Further, the device interface module 104 of device #2 writes the address on the bus 102 to the address register. The above-described device identification and assignment process may be repeated to identify and assign addresses to all N devices on the bus 102.

FIG. 4 illustrates a single pin bi-directional interface system 400 showing N number of devices 430, 432, 434 and a host 402 connected to the bus 404. Each device 430, 432, 434 has a device interface module and an address identification and assignment module 410, 412, 414, along with a corresponding RC circuit 420, 422, 424. Each RC circuit 420, 422, 424 provides a different time constant to identify the device 430, 432, 434. For example, device #1 (430) has an RC circuit 420 that provides a first time constant formed by a resistor R and a capacitor C₁. Device #2 (432) has an RC circuit 422 that provides a second time constant formed by a resistor R and a capacitor C₂, and so on. Therefore, device #N (434) has an RC circuit 424 that provides an N-^{th} time constant formed by a resistor R and a capacitor Cₙ.

In one embodiment, the time constant of device #1 is configured to be the longest time constant while the time constant of device #N is the shortest time constant. Thus, in this embodiment, the host 402 may first issue an initiation pulse with a longest pulse to identify and assign device #1. The host 402 may then issue a next longest initiation pulse to identify and assign device #2, and so on. In an alternative embodiment, the host 402 may first issue an initiation pulse with a shortest pulse to identify and assign device #N. The host 4092 may then successively issue longer initiation pulses to identify and assign other devices.

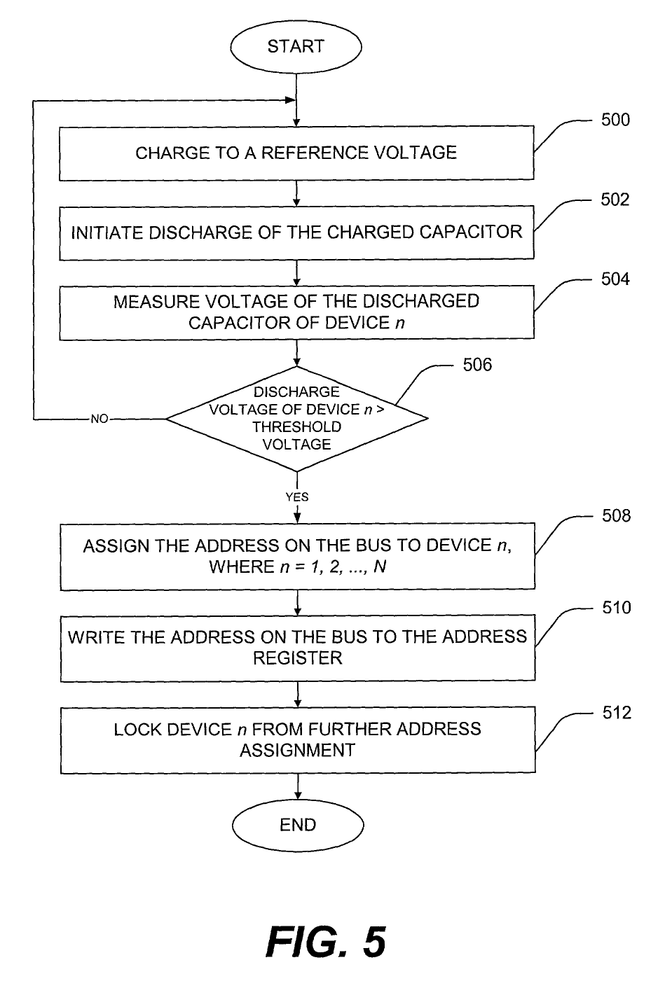

A device address identification and assignment process in accordance with an embodiment of the present invention is shown in FIG. 5. The process includes charging the capacitor of a particular size to a reference voltage at 500. The size of the capacitor is pre-selected to provide a specified time constant corresponding to device n, where n=1, 2, . . . , N. In response to a first host command, such as leading edge of an initiation pulse, the capacitor is discharged, at 502. Then, in response to a second host command, such as trailing edge of the initiation pulse, the voltage of the discharged capacitor is measured, at 504.

In the illustrated embodiment, if the voltage of the discharged capacitor of device n is greater than the threshold voltage (V_{TH}), at 506, the address on the bus 102 is assigned to device n, at 508. All other devices are either locked out or voltages of the discharged capacitors are less than the threshold voltage. In an alternative embodiment, the host commands may be configured in such a way that the address on the bus 102 is assigned to device n when the voltage of the discharged capacitor of device n is less than the threshold voltage. All other devices are either locked out or voltages of the discharged capacitors are greater than the threshold voltage.

When the address is assigned to device n at 508, this address is written to an address register of the device interface module 104, at 510. Moreover, device n is configured to lock itself from further address assignment, at 512.

In a further embodiment, the address identification and assignment process may be configured to provide a combination of resistor and capacitor of selected sizes. The combination produces a particular time constant, which may be compared to a threshold time. Thus, identification and assignment of the device address may be made according to an outcome of the comparison. In one embodiment, the assignment may be made when the time constant is greater than the threshold time. In another embodiment, the assignment may be made when the time constant is less than the threshold time.

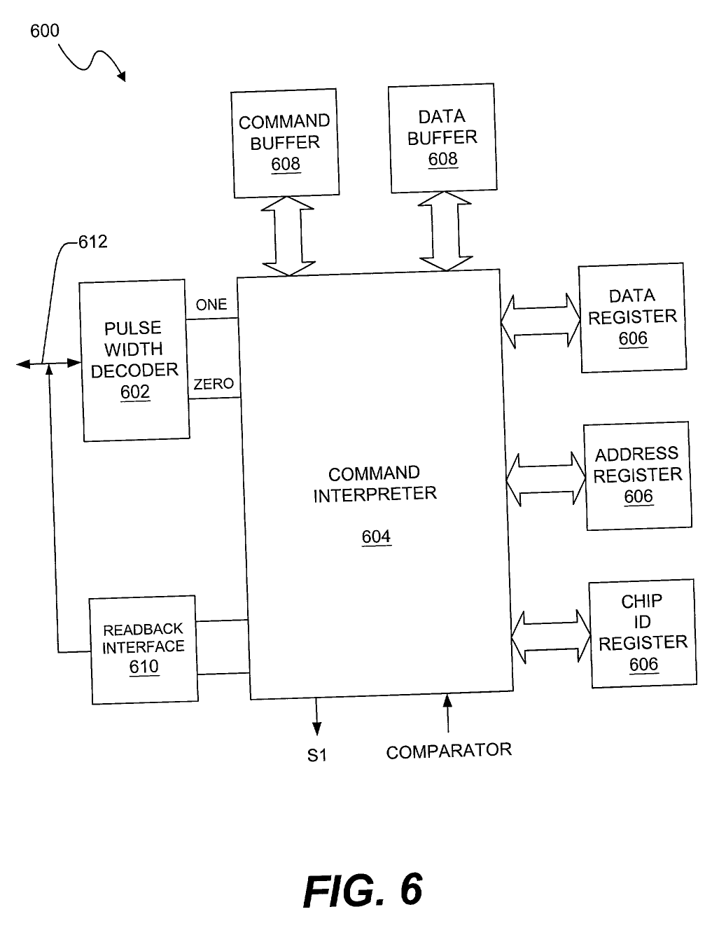

FIG. 6 is a block diagram of the device interface module 600 according to an embodiment. This module 600 is substantially equivalent to the interface module 104 in FIG. 1. The device interface module 600 includes pulse width decoder 602, a command interpreter 604, data and address registers 606, and data and command buffers 608. The device interface module 600 also includes a readback interface 610. The device interface module 600 may either read or write from the one-wire interface 612 as follows. The read and write modes are referenced with respect to the host.

In a write mode, the pulse width decoder 602 accepts the incoming data pulse stream on the one-wire interface 612. Using timing elements in the decoder 602, the decoder 602 distinguishes between a logical “0” and a logical. The categorized pulses are sent to the command interpreter 602, which then identifies the desired command and takes appropriate action in response. The command interpreter 602 utilizes data buffers 608 and registers 606 as necessary to complete the operation. Furthermore, the command interpreter 602 may send a command to the switch 202 in the address identification and assignment module 210, and receive a signal back from the module 210, to identify and assign address to the present device connected to the device interface module 600.

In a read mode, the host may send appropriate commands to initiate the read operation. The command interpreter 602 recognizes the command and waits for a prompt from the host. After receiving a valid prompt, the command interpreter 602 may transmit the logic level of the first bit in the address register 606 to the readback interface 610. The readback interface 610 may then place the received bit on the one-wire interface 612. The host has a specific amount of time in which to read the logic level of the bit. After this time, the device interface module 600 releases the interface 612 (i.e. the module 600 presents high impedance to the interface 612) and waits for another valid prompt from the host. This sequence may be repeated until all bits in the address and/or data registers have been transmitted to the host.

There has been disclosed herein embodiments for a single-pin interface having dynamic address assignment, which includes dynamically identifying and assigning an address using a uniquely specified time constant for each device connected to the one-wire bus. The time constant, which is specified by a voltage of the discharged capacitor at a certain point in time, is compared to a threshold voltage to determine whether the destination of the address placed on the bus is intended for the present device.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the embodiments may be practiced without some of these specific details. For example, the parts in FIG. 2, such as a switch, an RC circuit, a voltage reference, and a comparator, may be replaced with any other functionally equivalent parts. In other instances, well-known structures and functions were not described in elaborate detail in order to avoid obscuring the subject matter of the present invention. Accordingly, the scope and spirit of the invention should be judged in terms of the claims which follow.

[image]

[image]

What is claimed is:

1. A method of identifying and assigning an address for a particular device connected to an interface, comprising:
discharging a capacitor in response to a first command from a host;
measuring a voltage of the discharged capacitor in response to a second command from the host; and
assigning the address to the particular device when the voltage indicates that the particular device is an intended destination of the address.

2. The method of claim 1, further comprising:
charging a capacitor of a specified size.

3. The method of claim 2, wherein the specified size of the capacitor is selected to provide a pre-determined level for the voltage of the discharged capacitor at the second command.

4. The method of claim 2, wherein the specified size of the capacitor is selected to provide a unique time constant measured between the first command and the second command from the host.

5. The method of claim 2, wherein said charging a capacitor includes charging the capacitor to a reference voltage.

6. The method of claim 1, wherein the interface is a one-wire bus.

7. The method of claim 6, wherein the one-wire bus is bi-directional.

8. The method of claim 1, wherein said assigning the address includes receiving and writing the address to an address register.

9. The method of claim 1, wherein said first command from a host includes a leading edge of an initiation pulse.

10. The method of claim 9, wherein said second command from the host includes a trailing edge of the initiation pulse.

11. The method of claim 1, wherein said measuring a voltage of the discharged capacitor includes comparing the voltage to a threshold voltage.

12. The method of claim 11, wherein an indication that the destination of the address intended by the host is the particular device is determined by an outcome of said comparing the voltage of the discharged capacitor to a threshold voltage.

13. The method of claim 12, wherein the outcome of said comparing includes the voltage being less than the threshold voltage.

14. The method of claim 12, wherein the outcome of said comparing includes the voltage being greater than the threshold voltage.

15. The method of claim 14, further comprising:
locking the particular device from further address assignment.

16. The method of claim 15, wherein said locking includes placing the particular device into a state that disables acceptance of future first and second commands from the host so that other devices with smaller time constants may be identified and assigned.

17. The method of claim 1, further comprising:
locking the particular device from further address assignment.

18. A method for identifying and assigning a device address, comprising:
providing a combination of resistor and capacitor of selected sizes, said combination producing a particular time constant;
comparing the particular time constant to a threshold time; and
identifying and assigning the device address according to an outcome of said comparing.

19. The method of claim 18, wherein the outcome provides that the particular time constant be greater than the threshold time.

20. The method of claim 18, wherein the outcome provides that the particular time constant be less than the threshold time.

21. An address identification and assignment system, comprising:
a combination of resistor and capacitor;
a voltage reference to provide a capacitor charge voltage and a threshold voltage;
a switching element to enable charging and discharging of the capacitor, where the capacitor is charged to the capacitor charge voltage; and
a comparator to compare voltage of the capacitor with the threshold voltage.

22. The system of claim 21, further comprising:
a command interpreter to command the switching element to charge and discharge the capacitor in response to commands from a host, said command interpreter receiving a device address when a result signal from the comparator indicates that a current device is intended destination of the device address.

23. The system of claim 22, further comprising:
an address register to store the device address.
